(19) United States
(12) Patent Application Publication
(10) Pub. No.: US 2003/0046709 A1
(43) Pub. Date: Mar. 6, 2003

(54) Digital broadcat system and method for enabling a viewer linkage to internet service providers via a channel remote controller

(75) Inventor: Lin Kuo-Wen, Chung-Ho City (TW)

Correspondence Address: TROXELL LAW OFFICE PLLC, SUITE 1404, 5205 LEESBURG PIKE, FALLS CHURCH, VA, 22041, US

(73) Assignee: 360SUN Digital Broadband Corporation

(21) Appl. No.: 10/040,625

(22) Filed: Jan. 9, 2002

(30) Foreign Application Priority Data
Sep. 6, 2001 (TW) 90122048

(51) Int. Cl. H04N 7/173; H04N 7/16

(52) U.S. Cl. 725/120; 725/109; 725/110; 725/116; 725/142

(57) ABSTRACT

The present invention provides a digital broadcast system and method for enabling a viewer linkage to internet service providers via a channel remote controller. The channel remote controller can transmit one of a plurality of channel request signals in response to the viewer's selection. Each channel request signal corresponds to one of the internet service providers. The system comprises a communication apparatus, a broadcast station communicating with the communication apparatus, and a terminal electrically connecting with the communication apparatus for display presentation from the linked internet service provider. The communication apparatus receives the signal from the channel remote controller, converts the signal into a corresponding script to link to the corresponding internet service provider, and transmits the corresponding script. The broadcast station receives the corresponding script from the communication apparatus, executes the linkage to the corresponding internet service provider in accordance with the corresponding script, and displays presentation from the linked internet service provider on the terminal. Thus, viewers can link to internet service providers by a way similar to controlling traditional TVs.

### FIELD OF THE INVENTION

The present invention relates to a digital broadcast system and method, and more particularly, to a digital broadcast system and method for enabling a viewer linkage to internet service providers via a channel remote controller.

### BACKGROUND OF THE INVENTION

With the advance of the internet, gathering resources or information from the internet has become more and more essential to people's daily life. The most common way for gathering information from the internet is using personal computer (PC) to connect to the internet service providers and get needed information. The internet service providers mentioned above refer to all types of websites that provide service via internet.

It is the trend that internet becomes part of family life. PC is gradually replaced by TV with set-top box (STB) or digital TV as a means for user to connect to internet resources. The goal is to allow users to access internet resources easily at home.

The prior way to operate TV with STB or digital TV to access internet is very similar to PC. Users need to have PC's peripherals like mouse and keyboard to enter desired URL to access specific website for particular resource or information. Or users need to use mouse to click on certain link for such internet resources. This way to operate TV with STB or digital TV is not user-friendly for those people not familiar with PCs.

Nevertheless, the way mentioned above is not conveniently for educated PC users. For example, it takes time & effort to key-in all letters of specific URL to access the website. Besides, it is very common that TV is sitting in user's living room where there is no appropriate equipment like computer desk for using mouse and keyboard. Users have to operate their keyboard and mouse on their knees or small table which makes the operation very difficult.

Therefore, for digital TV to become major means of internet access at home, it is very critical to improve the way of operating it. There have been many development in improving the way of operating digital TV. The goal is to allow users to access internet easily at home. Like U.S. Pat. Nos. 6,240,555, 6,184,877 and 6,229,524, etc. are related to such efforts. However, these patents or prior art methods still present solutions very similar to the way of using PC but unable to provide a way to access internet as easy as using traditional TV.

Therefore, the primary objective of the present invention is to provide a method for enabling a viewer linkage to internet service providers via a channel remote controller. Thus, without learning new methods, viewers can conveniently link to internet service providers by a way similar to controlling traditional TVs to solve the above mentioned problems.

### SUMMARY OF THE INVENTION

It is therefore a primary objective of the present invention to provide a method for enabling a viewer linkage to internet service providers via a channel remote controller. Thus, viewers can conveniently link to internet service providers through digital TVs by a way similar to controlling traditional TVs.

In a preferred embodiment, the present invention provides a digital broadcast system for enabling a viewer linkage to internet service providers via a channel remote controller. The channel remote controller is capable of transmitting one of a plurality of channel request signals in response to the viewer's selection, each channel request signal corresponding to one of the internet service providers. The digital broadcast system comprises a communication apparatus, a broadcast station communicating with the communication apparatus, and a terminal device electrically connecting with the communication apparatus for display presentation from the linked internet service provider. The communication apparatus receives the channel request signal transmitted from the channel remote controller, converts the received channel request signal into a corresponding script representing a request to link to the corresponding internet service provider, and transmits the corresponding script. The broadcast station receives the corresponding script transmitted from the communication apparatus, executes the linkage to the corresponding internet service provider in accordance with the corresponding script, and displays presentation from the linked internet service provider on the terminal device.

In another preferred embodiment, the present invention provides a digital broadcast method which comprises following steps. First, receive the channel request signal transmitted from the channel remote controller. Then convert the received channel request signal into a corresponding script representing request to link to the corresponding internet service provider. Execute the linkage to the corresponding internet service provider in accordance with the corresponding script. Finally, display the presentation from the linked internet service provider.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a schematic diagram of a digital broadcast system 10 according to a preferred embodiment of the present invention.

FIG. 2 is a information processing flow chart of the digital broadcast system 10 according to the preferred embodiment of the present invention.

### DETAILED DESCRIPTION OF THE PREFERED EMBODIMENT

The primary objective of the present invention is to provide a method for enabling a viewer linkage to internet service providers via a channel remote controller. Thus, viewers can conveniently link to internet service providers via digital TVs (or TV equipped with STB) by using the method similar to controlling traditional TVs.

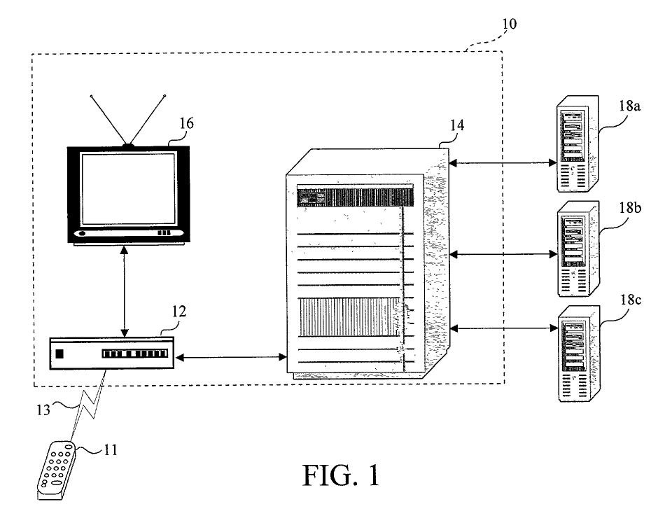

Referring to FIG. 1, FIG. 1 is a schematic diagram of a digital broadcast system 10 according to the preferred embodiment of the present invention. The digital broadcast system 10 enables a viewer linkage to internet service providers (18a-18c) via a channel remote controller 11. The channel remote controller 11 is capable of transmitting one of a plurality of channel request signals 13 in response to the viewer's selection. Each of the channel request signals corresponds to one of the internet service providers (18a-18c).

The digital broadcast system 10 comprises a communication apparatus 12, a broadcast station 14 communicating with the communication apparatus 12, and a terminal device 16 electrically connecting with the communication apparatus 12 for displaying presentation from the linked internet service provider. The communication apparatus 12 receives the channel request signal transmitted from the channel remote controller 11, converts the received channel request signal into a corresponding script representing a request to link to the corresponding internet service provider, and transmits the corresponding script. The broadcast station 14 receives the corresponding script transmitted from the communication apparatus 12, executes the linkage to the corresponding internet service provider in accordance with the corresponding script, and displays presentation from the linked internet service provider on the terminal device 16. For example, The broadcast station 14 displays a web page of CNN news site on the terminal device 16.

In an embodiment, the communication apparatus 12 receives the channel request signal transmitted from the channel remote controller 11, converts the received channel request signal into a corresponding script representing a request to link to the corresponding internet service provider, and transmits the corresponding script. The communication apparatus 12 comprises a memory device (not shown in FIG. 1) for storing correspondence between the channel request signals and the corresponding scripts. The correspondence between the channel request signals and the corresponding scripts indicates channel functions provided by the digital broadcast system. For example, the internet service provider 18a corresponds to channel 32, the internet service provider 18b corresponds to channel 36, and the internet service provider 18c corresponds to channel 38. In practice, the information about channels to corresponding internet service providers will also be displayed on the terminal device 16 for informing viewers the correspondence between channels and internet service providers. Therefore, the viewer can use the channel remote controller 11 to transmit channel request signals.

In one embodiment, the communication apparatus 12 is embodied as a set-top box. In another embodiment, the communication apparatus 12 connecting the terminal device 16 is embodied as a digital television.

In one embodiment, the corresponding scripts are Java scripts. In another embodiment, the corresponding scripts are VB (Visual Basic) Script.

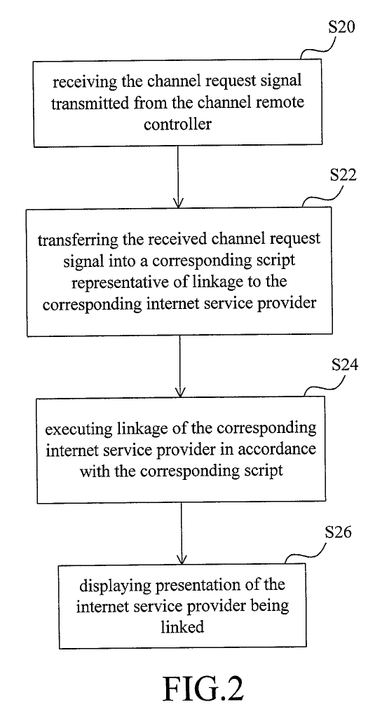

Referring to FIG. 2., FIG. 2 is an information processing flow chart of digital broadcast system 10 according to the preferred embodiment of the present invention. The preferred embodiment comprises the steps of:

S20: receiving the channel request signal 13 transmitted from the channel remote controller 11;

S22: converting the received channel request signal into a corresponding script representing a request to link to the corresponding internet service provider;

S24: executing the linkage to the corresponding internet service provider in accordance with the corresponding script; and

S26: displaying presentation from the linked internet service provider on the terminal device 16.

The present invention provides a digital broadcast system and method for enabling a viewer linkage to internet service providers via a channel remote controller. Thus, viewers can easily and conveniently link to internet service providers through digital TV or TV with STB at home by a way similar to controlling traditional TVs. And hence, the invention provides a easy way for those users not skilled at PC to operate digital TV to connect to internet resources.

With the examples and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A digital broadcast system for enabling a viewer linkage to a plurality of internet service providers via a channel remote controller, the channel remote controller being capable of transmitting one of a plurality of channel request signals in response to the viewer's selection, each channel request signal corresponding to one of the internet service providers, said system comprising:
a communication apparatus for receiving the channel request signal transmitted from the channel remote controller, converting the received channel request signal into a corresponding script representing a request to link to the corresponding internet service provider, and transmitting the corresponding script;
a broadcast station, communicating with the communication apparatus, for receiving the corresponding script transmitted from the communication apparatus, executing linkage of the corresponding internet service provider in accordance with the corresponding script, and displaying presentation from the internet service provider being linked; and
a terminal electrically connecting with the communication apparatus, the broadcast station displaying the presentation of the internet service provider being linked on the terminal via the communication apparatus.

2. The system of claim 1, wherein the communication apparatus comprises a memory device for storing correspondence between the channel request signals and the corresponding scripts.

3. The system of claim 2, wherein the communication apparatus is embodied as a set-top box.

4. The system of claim 2, wherein the communication apparatus and viewer terminal are embodied as a digital television.

5. The system of claim 3, wherein the corresponding scripts are Java scripts.

6. The system of claim 3, wherein the corresponding scripts are VB scripts.

7. A digital broadcast method for enabling a viewer linkage to a plurality of internet service providers via a channel remote controller, the channel remote controller being capable of transmitting one of a plurality of channel request signals in response to the viewer's selection, each channel request signal corresponding to one of the internet service providers, said method comprising the steps of:
receiving the channel request signal transmitted from the channel remote controller;
converting the received channel request signal into a corresponding script representative of linkage to the corresponding internet service provider;
executing linkage of the corresponding internet service provider in accordance with the corresponding script; and
displaying presentation from the internet service provider being linked.

8. The method of claim 7, wherein the corresponding scripts are Java scripts.

9. The method of claim 7, wherein the corresponding scripts are VB scripts.
